(19) United States
(12) Patent Application Publication
(10) Pub. No.: US 2003/0087040 A1
(43) Pub. Date: May 8, 2003

(54) Method for the automatic application of a surface coating

(76) Inventor: Klaus Ladentin, Ober-Moerlen (DE)

Correspondence Address: The Law Offices of Timothy J. Klima, Suite 330, One Massachusetts Avenue NW, Washington, DC, 20001, US

(21) Appl. No.: 10/287,719

(22) Filed: Nov. 5, 2002

(30) Foreign Application Priority Data
Nov. 5, 2001 (DE) 101 54 284.4

(51) Int. Cl. B05D 1/02

(52) U.S. Cl. 427/421

(57) ABSTRACT

A method for the automatic application of a surface coating on a metallic component in which the material of the surface coating is deposited by a spraying process in liquid, doughy or only molten-on condition, wherein a coating thickness obtained is automatically measured after at least one surface-coating cycle, compared with a specified value and a residual coating thickness required is calculated, a further surface-coating cycle is subsequently performed as required, and this procedure is repeated to obtain the required thickness of the surface coating.

This application claims priority to German Patent Application DE10154284.4, filed Nov. 5, 2001, the entirety of which is incorporated by reference herein.

### BACKGROUND OF THE INVENTION

This invention relates to a method for the automatic application of a surface coating on a metallic component, in which the material of the surface coating is deposited by a spraying process in liquid, doughy or only molten-on condition.

Specifically, this invention relates to a method for the automatic application of a surface coating by means of a plasma-spray process or a flame-spray process. Such processes can generally be referred to as coating processes.

In said processes, as is known in the state-of-the-art, a powder material is molten-on and its particles are deposited at high speed onto the component to which they adhere firmly. Such coating processes are performed in cycles, which means that as many individual cycles of material application are performed consecutively as are necessary to obtain the desired thickness of the surface coating.

A disadvantage of said procedure lies in the fact that the thickness of the surface coating applied in one cycle is not exactly pre-determinable. A variety of different parameters may influence the coating thickness, for example degradation of the burner or swirling at the surface of the component.

Therefore, in the state-of-the-art, the coating thickness requires inspection either after each cycle or after a given number of cycles. In so doing, it is particularly disadvantageous that the entire equipment must be shut down to permit the operators to access the component.

These disadvantages are known in the state-of-the-art and respective measures have already been proposed. Specification DE 44 19 476 C2, for example, describes a method and an apparatus for the determination of both the coating thickness and the substrate temperature during coating application. Here, reflectance is measured by means of a reflectometer. The theoretical coating thickness is obtained from the measuring curve of the reflectometer. A similar method is described in U.S. Pat. No. 5,564,830.

It must be noted, however, that these known methods have only limited usability since they incur very high apparative requirements and are only appropriate for certain components or applications, for example in the semi-conductor industry.

Therefore, these methods are to be ruled out for conventional components, as used in mechanical engineering or in aero-engine manufacture.

The conventional procedure, in which the equipment is shut down, is disadvantageous in that the entire process must be stopped before and re-started after measurement. Besides the process time required and the costs incurred, a further problem lies in the fact that the coating thickness cannot be measured repetitively at one and the same location, a fact which may result in measuring errors.

Alternatively, it has been proposed to coat a measuring or reference sample, for example a plate, together with the actual component and to determine the coating thickness from this sample. However, this method lacks precision, too, since surface effects and flow conditions of the sample and the like will not agree exactly with the conditions of the actual component.

### SUMMARY OF THE INVENTION

In a broad aspect, the present invention provides a method of the type cited at the beginning which enables the surface coating thickness to be measured automatically and the process to be controlled appropriately, while being simply designed and easy and safe to operate.

It is a particular object of the present invention to provide a method featuring the characteristics described herein, with further advantageous developments of the present invention being described below.

Accordingly, the method according to the present invention provides for automatic measurement of the coating thickness obtained after at least one cycle of surface-coating application, comparison with a specified value, calculation of the residual coating thickness required and execution of a further cycle of surface-coating application, if and as required. According to the present invention, this procedure is repeated until the required thickness of the surface coating is obtained.

The method according to the present invention is characterized by a variety of merits.

The method does not require the entire equipment to be deactivated or shut down for manual measurement of the surface coating thickness of the component. Rather, measurement is performed automatically between the individual coating cycles.

In accordance with the present invention, the coating can be applied by means of robotic equipment, thus enabling exact adaptation to the geometry of the component to be coated. As known from the state-of-the-art, the robotic equipment is provided within an enclosed system. Accordingly, the present invention also provides for means for measuring the coating thickness within the enclosed system.

It is an advantage that the entire coating process can be performed automatically. With the individual coat thicknesses being adjusted over the cycles and the coating thickness being measured automatically between the cycles, the automatic process can be based directly on the desired thickness of the surface coating. Additional coating of reference samples or similar is not required.

Another important advantage of the present invention lies in the fact that it provides for precise automatic measurement of the coating thickness without the equipment having to be shut down. Therefore, the equipment downtime will be minimal, with the plasma or flame spray robot being deactivated for a short period only. This means that the equipment need not be shut down completely; in particular the robot need not be deactivated. The robot program keeps on running during the measurement of the coating thickness; in the scope of this program the coating thickness is determined. Obviously, the flame must be switched off during the measurement of the coating thickness. Other units, such as an exhausting device, door lock, etc. remain on.

Furthermore, it is particularly advantageous that manual measurement is not required, thus excluding reading errors or similar occurrences.

Another important advantage of the automatic process lies in the fact that even the most intricate geometric contours can be sampled with consistent measuring accuracy.

The entire operation of the equipment is highly simplified since in the main it is only necessary to program the automatic process accordingly.

In accordance with the present invention, it is particularly favourable if automatic compensation of degradation, for example of the burner parts or similar, is provided for.

In addition, the present invention provides for storage and logging of the acquired data. This allows the entire process to be traced and checked precisely.

As a further advantage, the present invention provides for retrofitting or upgrading of existing equipment, which results in generally low investment costs.

It is particularly favourable to calculate the coating thickness to be applied and to control the cycle accordingly. This is simply achievable by adjusting the process parameters.

It may further be advantageous to check the maximum possible number of cycles during the automatic calculation of the number of cycles to avoid overloading of the component or the equipment and obtain a metallurgically perfect coating build-up.

In order to preclude measuring errors, it can be advantageous to perform adjustment relative to the basic size of the uncoated component prior to process start. Also, depending on the form of the method according to the present invention, it may in any case be necessary to perform said adjustment prior to process start, this being due to the fact that plus dimensions are measured only.

Automatic measurement of the coating thickness is preferably carried out by means of a mechanical probe. Such probes are inexpensive and reliable and feature a high degree of precision.

The process according to the present invention may, for example, encompass the following steps:

closing the equipment,

starting the program,

entry of the desired thickness of surface coating and bond coat,

automatic determination of basic dimension or basic size of the component,

starting-up of the flame,

automatic heat-up of the component by heating the rotor with the burner using the robot,

moving the robot into starting position,

switching on the powder supply,

coating the component attached to the rotor with a specified, component-related initial number of cycles using the robot,

shutting-down of the flame,

removal of the robot into the initial position,

moving of the measuring probe to the component using the robot,

determination of the thickness of the surface coating applied,

automatic calculation of the number of cycles still required,

re-start of the process with start-up of the flame.

Typically, the above process procedure is carried out twice for the application of the bond coat and three times for the application of the top coat.

### BRIEF DESCRIPTION OF THE DRAWINGS

FIG. 1 shows a flow chart of the automatic coating process; and

FIG. 2 shows the calculating steps for the determination of the number of cycles which are still to be performed, as provided for in FIG. 1.

### DETAILED DESCRIPTION OF THE INVENTION

This detailed description should be read in conjunction with the details provided in the summary of the invention section above.

As already mentioned, the present invention provides for one each automatic measurement process by coupling a measuring probe with the robot control, to determine the thickness of the surface coating actually applied. From the result obtained, the control calculates the thickness of the surface coating which is still to be applied. In turn, this gives the number of cycles which are still to be executed automatically by the equipment. Upon start of the process, the operator must merely enter the desired thickness of the surface coating. The equipment controls itself automatically until the finished component with the desired surface coating thickness is obtained. All interim results can be logged or printed out, if required. Accordingly, the coating process is of the fully automatic type, thus providing for a considerable savings in time and a substantial enhancement of quality.

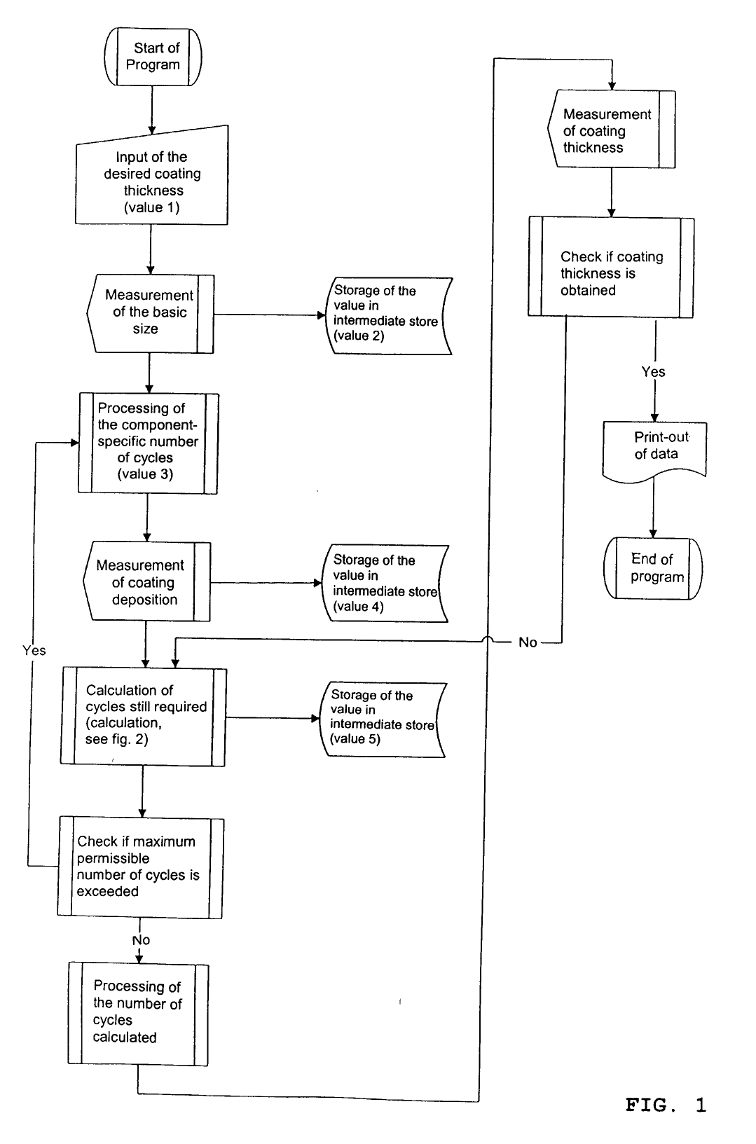

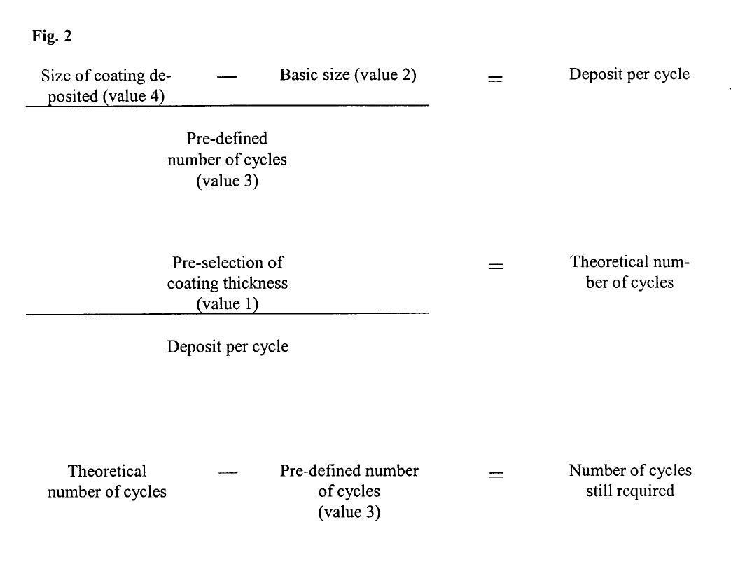

FIG. 1 shows a flowchart for the method of one embodiment of the present invention. There, the program is started. The desired coating thickness is input to the program as value 1. The basic size of the component is measured and stored in an intermediate store as value 2. The component is then processed a component-specific number of cycles (value 3). The object with the coating deposition is then measured and this measurement is stored in an intermediate store as value 4. The number of cycles still required is calculated per the calculation shown in FIG. 2 and described below. This number is stored in an intermediate store as value 5. A check is then made to determine if the maximum permissible number of cycles has been exceeded. If the maximum permissible number of cycles has not been exceeded, the number of cycles calculated is processed. The coating thickness is then measured and checked to determine if the desired coating thickness has been obtained. If so, a printout of the program is made and the program is ended.

If the maximum permissible number of cycles has been exceeded, the program returns to the step of processing the component-specific number of cycles and resumes the next steps.

If the desired coating thickness has not been obtained when checked, the program returns to the step of calculation of the cycles still required and resumes the next steps.

FIG. 2 shows the calculation of the number of cycles still required. First, the size of the basic component (value 2) is subtracted from the size of the component with coating deposited (value 4) and the sum divided by the pre-defined number of cycles (value 3) to determine the coating deposit per cycle. The desired coating thickness (value 1) is divided by the deposit per cycle to determine the theoretical number of cycles. The pre-defined number of cycles (value 3) is then subtracted from the theoretical number of cycles to determine the number of cycles still required.

While the method according to the present invention is applicable for the repair of components, for example of aero-engines, it is primarily used for new parts. However, the method according to the present invention is not limited to engine manufacturing (aero gas turbines or stationary gas turbines), but is also applicable in the automotive industry and the general mechanical engineering field.

What is claimed is:

1. A method for the automatic application of a surface coating on a metallic component, in which the material of the surface coating is deposited by a spraying process in at least one of a liquid, doughy and only molten-on condition, wherein:
a coating thickness obtained is automatically measured after at least one surface-coating cycle,
the coating thickness obtained is compared with a specified value and a residual coating thickness required is calculated,
a further surface-coating cycle is subsequently performed as required, and
this procedure is repeated to obtain a required thickness of the surface coating.

2. A method as in claim 1, wherein the coating thickness to be applied in a cycle is automatically calculated and the cycle is controlled accordingly.

3. A method as in claim 2, wherein a check is made for a maximum possible number of cycles during automatic calculation of the cycle number.

4. A method as in claim 3, wherein an adjustment relative to a basic size is made prior to commencement of work.

5. A method as in claim 4, wherein a mechanical measuring probe is used for automatic measurement of the coating thickness.

6. A method as in claim 1, wherein a check is made for a maximum possible number of cycles during automatic calculation of the cycle number.

7. A method as in claim 6, wherein an adjustment relative to a basic size is made prior to commencement of work.

8. A method as in claim 7, wherein a mechanical measuring probe is used for automatic measurement of the coating thickness.

9. A method as in claim 1, wherein an adjustment relative to a basic size is made prior to commencement of work.

10. A method as in claim 9, wherein a mechanical measuring probe is used for automatic measurement of the coating thickness.

11. A method as in claim 1, wherein a mechanical measuring probe is used for automatic measurement of the coating thickness.

12. A method as in claim 2, wherein an adjustment relative to a basic size is made prior to commencement of work.

13. A method as in claim 12, wherein a mechanical measuring probe is used for automatic measurement of the coating thickness.

14. A method as in claim 2, wherein a mechanical measuring probe is used for automatic measurement of the coating thickness.

15. A method as in claim 3, wherein a mechanical measuring probe is used for automatic measurement of the coating thickness.

16. A method as in claim 6, wherein a mechanical measuring probe is used for automatic measurement of the coating thickness.
